(19) United States
(12) Patent Application Publication
(10) Pub. No.: US 2018/0255920 A1
(43) Pub. Date: Sep. 13, 2018

(54) Adjustable Support For Computer Peripherals

(71) Applicants: Summer Lynn Currie, Rossville, GA (US); James Ryan Currie, Rossville, GA (US)

(72) Inventors: Summer Lynn Currie, Rossville, GA (US); James Ryan Currie, Rossville, GA (US)

(21) Appl. No.: 15/451,865

(22) Filed: Mar. 7, 2017

(51) Int. Cl. A47B 21/02; A47B 21/04; F16M 11/04; F16M 11/12; F16M 11/18; F16M 13/02

(52) U.S. Cl. CPC A47B 21/02; A47B 21/04; F16M 13/02; F16M 11/126; F16M 11/18; F16M 11/046

(57) ABSTRACT

Methods and systems for configuring a computer peripheral support and organizer apparatus are described. An example method can comprise adjusting a first support assembly to a first position on the bar. The first support assembly can comprise a first fastener mounted on the bar and adjustable for selective positioning along the bar. The first support assembly can comprise a tray attached to the first fastener. The tray can be configured to such that a keyboard, mouse, microphone, or any similar computer peripheral may be placed upon it. Additionally, an example method can comprise adjusting a second support assembly to a position along a bar. The second support assembly can comprise a second fastener mounted on the bar and adjustable for selective positioning along the bar. The second support assembly can comprise a mount configured to mount a display, projector, or any similar computer peripheral to the second fastener.

### BACKGROUND

Height-adjustable desks (e.g., stand-up desk) enable a person to stand while operating a computer or engaging in some other function that is traditionally performed at a conventional desk. Such desks are particularly useful to people with back ailments and/or injuries, or people who generally find it beneficial to stand while working rather than sit for long periods of time. However, many existing stand-up desks are costly and allow only for adjustment of the entire desk surface, which is typically heavy and therefore requires more than one and/or very large mechanism(s) to be provided. As such, existing desk apparatuses are often bulky, cumbersome, costly and difficult to manage. Thus, there is a need for more sophisticated cost efficient height-adjustable devices for greater flexibility and ease of management.

### SUMMARY

It is to be understood that both the following general description and the following detailed description are exemplary and explanatory only and are not restrictive, as claimed. Provided are methods and systems for configuring a computer peripheral support and organizing apparatus.

Provided is an apparatus for supporting and organizing computer peripherals. The apparatus can comprise a bar with a first support assembly mounted on the bar. The first support assembly can comprise a first fastener, enabling the first support assembly to be adjustable for selective positioning along the bar. The first support assembly can comprise a tray attached to the first fastener. The apparatus can comprise a second support assembly mounted on the bar via a second fastener. The second fastener can be adjustable for selective positioning along the bar. The second support assembly can comprise a mount configured to mount a display to the second fastener. In an aspect, the first fastener can be selectively moveable along the bar independently from the second fastener and the second fastener can be selectively moveable along the bar independently of the first fastener.

Provided is an apparatus for supporting and organizing computer peripherals. The apparatus can comprise a base and a bar having a first end supported by the base. The apparatus can comprise a first support assembly adjustably mounted on the bar. The first support assembly can comprise a first fastener, a first trigger for actuating movement of the first support assembly along the bar, and a first mounting element extending from the first fastener. The first fastener can comprise a first sleeve extending through the first fastener. The first sleeve can be configured for mounting the first support assembly on the bar. The first mounting element can be affixed to a tray. The apparatus can comprise a second support assembly adjustably mounted on the bar. The second support assembly can comprise a second fastener, a second trigger for actuating movement of the second support assembly along the bar, and a second mounting element extending from the second fastener. The second fastener can comprise a second sleeve extending through the second fastener. The second sleeve can be configured for mounting the second support assembly on the bar. The second mounting element can be affixed to a mounting bracket configured to mount a display. The first support assembly can be selectively moveable along the bar independently from the second support assembly. The second support assembly can be selectively moveable along the bar independently of the first support assembly.

Provided is a method for configuring a support for computer peripherals. The method can comprise adjusting a first support assembly to a first position along a bar. The first support assembly can comprise a first fastener mounted on the bar and adjustable for selective positioning along the bar. The first support assembly can comprise a tray attached to the first fastener that enables a keyboard, mouse, camera, or any other similar element/device to be placed upon the tray. The method can comprise adjusting a second support assembly to a second position on the bar. The second support assembly can comprise a second fastener mounted on the bar and adjustable for selective positioning along the bar. The second support assembly can comprise a mount configured to mount a display to the second fastener.

Additional advantages and features will be set forth in part in the description which follows or may be learned by practice. The advantages and features will be realized and attained by means of the elements and combinations particularly pointed out in the appended claims. Other advantages and features will become apparent to one with skill in the art upon examination of the following drawings and detailed description. It is intended that all such additional advantages and features be included herein within the scope of the present invention.

### BRIEF DESCRIPTION OF THE DRAWINGS

The accompanying drawings, which are incorporated in and constitute a part of this specification, illustrate embodiments and together with the description, serve to explain the principles of the methods and systems:

FIG. 1A is an example apparatus for organizing and supporting computer peripherals;

FIG. 1B is an example clamp design for a support assembly;

FIG. 1C is an example tray design for a support assembly;

FIG. 1D is an example display mount for a support assembly;

FIG. 1E is another view of an example display mount;

FIG. 2 is an example apparatus for organizing and supporting computer peripherals;

FIG. 3A is an example of an internal configuration of a portion of an apparatus for organizing and supporting computer peripherals;

FIG. 3B is an example of an internal configuration of a portion of an apparatus for organizing and supporting computer peripherals;

FIG. 4 is an example apparatus for organizing and supporting computer peripherals;

FIG. 5 is an example apparatus for organizing and supporting computer peripherals; and

FIG. 6 is an example apparatus for organizing and supporting computer peripherals.

### DETAILED DESCRIPTION

Before the present methods and systems are disclosed and described, it is to be understood that the methods and systems are not limited to specific methods, specific components, or to particular implementations. It is also to be understood that the terminology used herein is for the purpose of describing particular embodiments only and is not intended to be limiting.

As used in the specification and the appended claims, the singular forms “a,” “an” and “the” include plural referents unless the context clearly dictates otherwise. Ranges may be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

“Optional” or “optionally” means that the subsequently described event or circumstance may or may not occur, and that the description includes instances where said event or circumstance occurs and instances where it does not.

Throughout the description and claims of this specification, the word “comprise” and variations of the word, such as “comprising” and “comprises,” means “including but not limited to,” and is not intended to exclude, for example, other components, integers or steps. “Exemplary” means “an example of” or and is not intended to convey an indication of a preferred or ideal embodiment. “Such as” is not used in a restrictive sense, but for explanatory purposes.

Disclosed are components that can be used to perform the disclosed methods and systems. These and other components are disclosed herein, and it is understood that when combinations, subsets, interactions, groups, etc. of these components are disclosed that while specific reference of each various individual and collective combinations and permutation of these may not be explicitly disclosed, each is specifically contemplated and described herein, for all methods and systems. This applies to all aspects of this application including, but not limited to, steps in disclosed methods. Thus, if there are a variety of additional steps that can be performed it is understood that each of these additional steps can be performed with any specific embodiment or combination of embodiments of the disclosed methods.

The present methods and systems may be understood more readily by reference to the following detailed description of preferred embodiments and the examples included therein and to the Figures and their previous and following description.

The present disclosure relates to an adjustable apparatus, for organizing and supporting computer peripherals. Described are systems and methods to form a portable sit to stand desk and/or computer terminal with supporting surfaces. The adjustable support apparatus can be disposed on a supporting surface (e.g., floor) to form a sit to stand desk comprising a base, a first support assembly elevated from the base, and a second support assembly elevated from the first support assembly. According to adjustable positioning of the first support assembly and second support assembly, the benefits of the described apparatus can be realized by persons either standing or sitting. In an aspect, the apparatus supports a variety of computer peripherals. For example, the first support assembly can support a keyboard, mouse, pen tablet, scanner, camera, microphone, or any other similar device, and the second support assembly can support a monitor, television, touchscreen, projector or any other similar device.

The present disclosure relates to an adjustable sit to stand device for adjusting the height of peripherals, such as monitors and keyboards. Unlike conventional sit to stand devices, the presently disclosed apparatus allows for independent movement of the monitor and keyboard. The presently disclosed apparatus is also lightweight and substantially least costly to manufacture than conventional sit to stand desks. The example apparatus can be easily carried and can comprise a base so that the apparatus can be placed upon any conventional desk. The example apparatus can comprise two independently moveable elements mounted upon a bar. One moveable element can support a monitor and another moveable element can support other peripherals, such as a keyboard, a mouse, and/or the like. According to the adjustable positioning of the moveable elements, the example apparatus can be configured for use as stand-up desk or a sit down desk. In some implementations, the present methods and devices can comprise a kit for assembling locally available parts (e.g., bar clamps) into lightweight, cost effective sit to stand desks that can be deployed in any office.

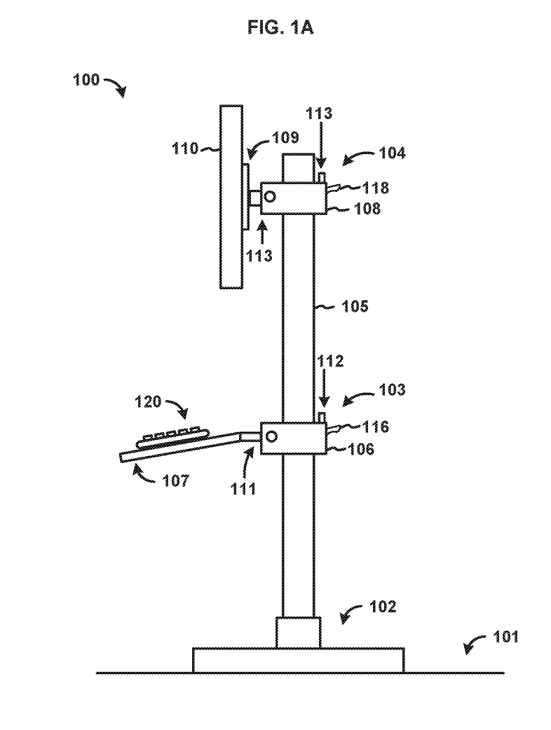

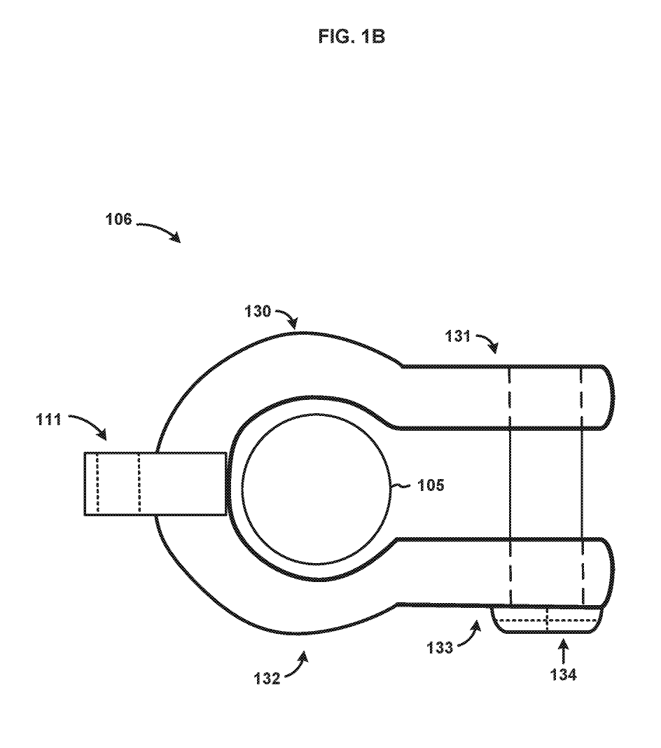

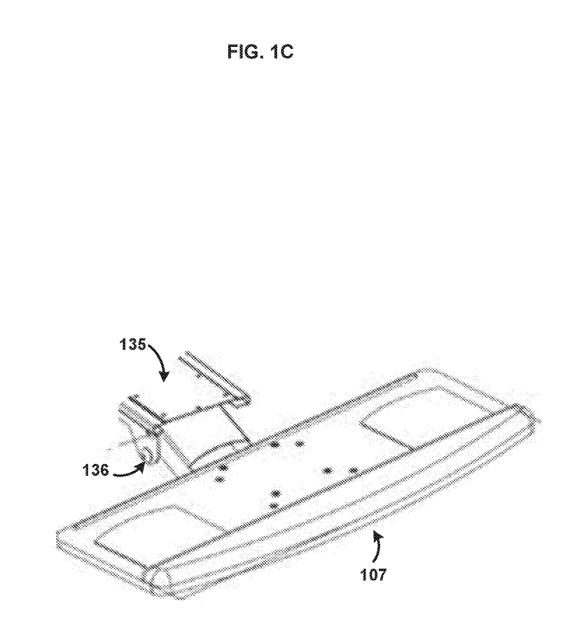

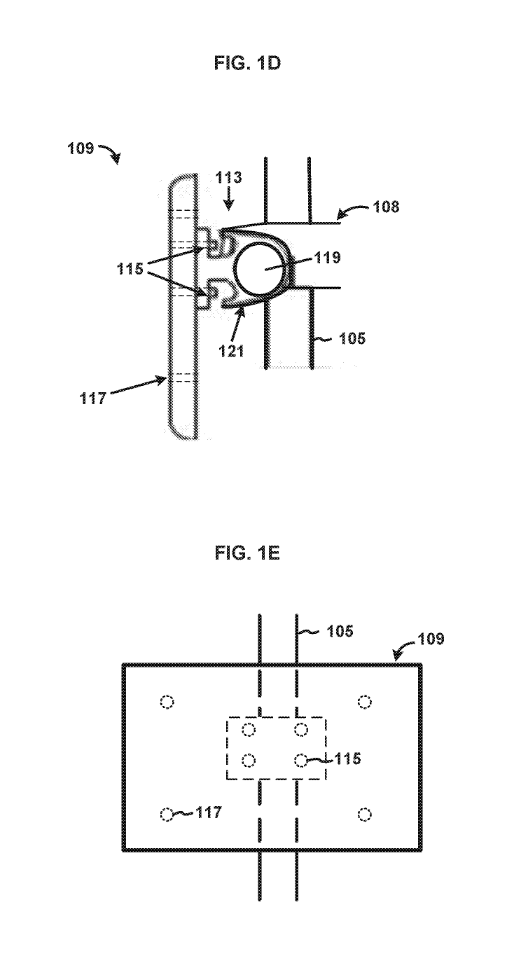

FIG. 1A illustrates an example apparatus 100 for supporting computer peripherals. In an aspect, the apparatus 100 can comprise a bar 105. The bar 105 can be cylindrically shaped. The bar 105 can have a cross-sectional shape (e.g., along the width) of a circle, ellipse, square, star, rectangular, triangle, or any other suitably shape. The bar 105 can be constructed from metal (e.g., aluminum, aluminum alloy), wood, hardened plastic, a combination thereof, and/or the like. In aspect, the bar 105 can be any appropriate length and diameter. As an illustration, the bar 105 can have a length within a range from about 2 feet to about 6 feet. The bar 105 can have a width (e.g., diameter) of between about 0.5 and about 3 inches. In another aspect, the bar 105 can be either solid or hollow according to user desired material and weight specifications.

In an aspect, the apparatus 100 can comprise a first support assembly 103 and a second support assembly 104. The first support assembly 103 and the second support assembly 104 can be adjustable for selective positioning along the bar 105. The first support assembly 103 can be adjusted (e.g., vertically) along the bar 105 independently from the second support assembly 104. The second support assembly 104 can be adjusted (e.g., vertically) along the bar 105 independently from the first support assembly 103.

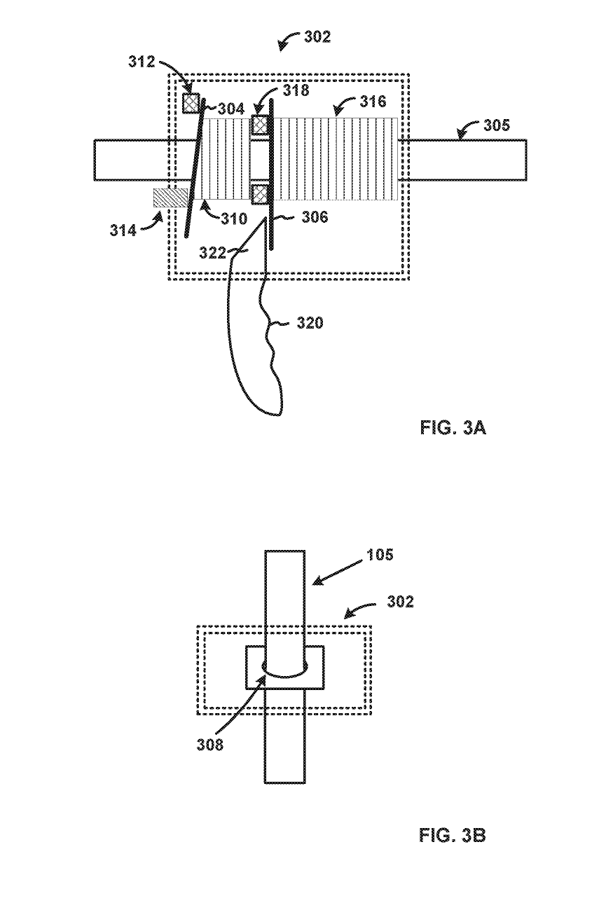

The first support assembly 103 can comprise a first fastener 106. The second support assembly 104 can comprise a second fastener 108. The first fastener 106 and the second fastener 108 can be mounted to (e.g., fastened, enclosed around) the bar 105. The first fastener 106 and the second fastener 108 can be adjustably fastened to the bar 105 for selective positioning along the bar 105. For example, both the first fastener 106 and the second fastener 108 can be fastened using a locking mechanism The locking mechanism can fasten to the bar 105 using friction, which can be released by pressing of a button. Example locking mechanisms are described in more detail in FIG. 1B, FIG. 3A, and FIG. 3B

FIG. 1B illustrates an example fastener design based on a clamping mechanism. The first fastener 106 can comprise a clamp assembly adapted to attach to an outer surface of the bar 105. For example, the first fastener 106 can comprise a first clamp member 130 with a first flange 131 and a second clamp member 132 with a second flange 133 corresponding to the first flange 131. The first clamp member 130 and the second clamp member 132 can conform to the outer surface of the bar 105. If the first clamp member 130 and the second clamp member 132 are placed on the outer surface of the bar 105, the first clamp member 130 and the second clamp member 132 can be fastened by fastening the first flange 131 and the second flange 133 towards each other with one or more screws 134, bolts, and/or the like. As such, the first clamp member 130 and the second clamp member 132 can be loosened and tightened together to be adjustably fastened to the bar 105 for selective positioning of the first support assembly 103 along the bar 105.

Returning to FIG. 1A, the first support assembly 103 can comprise a tray 107 attached to the first fastener 106. The tray 107 can be mounted to the first fastener 106 via a first tilt control element 111 that enables pivoting motion of the tray 107. In an aspect, the first tilt control element 111 can comprise a cylindrical member that passes through aligned openings in the first fastener 106 and the tray 107. The first tilt control element 111 can comprise a roughened surface (e.g., Grooves) and/or other mechanism that allows for radial adjustment between fixed positions. The roughened surface can interface with a similar surface disposed on the second fastener 108. Rotation of the first tilt control element 111 can enable user adjustable angle positioning of the tray 107. As such, the first tilt control element 111 can enable a user to tilt the tray 107 to a desired angle. In an aspect, the first tilt control element 111 can enable user adjustable angle positioning of the tray 107 as described or via any other suitable means. For example, the first tilt control element ill can comprise an adjustable hinge or any other suitable device/mechanism known in the art.

In an aspect, the first support assembly 103 and the second support assembly 104 can both be configured to rotate around the bar 105 (e.g., when disengaged from the bar 105). The first support assembly 103 can comprise a first handle 116. The first handle 116 can be held while a user rotates and/or moves the first support assembly 103 along the bar 105. The second support assembly 104 can comprise a second handle 118. The second handle 118 can be held while a user rotates and/or moves the first support assembly 103 along the bar 105.

FIG. 1C is a prospective view illustrating an example tray 107. The tray 107 is shown attached to an example fastener 135 (e.g., used as the first fastener 106 and/or the second fastener 108) via an example tilt control element 136 (e.g., first tilt control element 111 and/or second tilt control element 113). In an aspect, the tray 107 can comprise metal (e.g. aluminum or aluminum alloy), acrylic, wood, hardened plastic, and/or any other suitable material. The tray 107 can be in the shape of a rectangle (e.g., with rounded edges). The tray 107 can be substantially planar. The tray 107 can support a peripheral, such as a keyboard 120 (e.g., see FIG. 1A), mouse, pen tablet, scanner, camera, microphone, mobile phone, or any other similar device. In an aspect, the tray 107 can be configured to transfer the load from the peripheral (e.g., keyboard 120) to the bar 105. In an aspect, the apparatus 100 can comprise additional support elements, such as additional trays, support arms, and/or the like. For example, the apparatus 100 can comprise two trays similar to tray 107 that extends from an enlarged first support assembly 103. As another example, additional support assemblies can be mounted on the bar 105 to support additional devices and objects for the user. The additional trays can provide support for another keyboard or any other similar computer peripheral or device.

Returning to FIG. 1A, the second support assembly 104 can comprise a mount 109 configured to mount a display 110 to the second fastener 108. The mount 109 can be mounted to the second fastener 108 via a second tilt control element 113 that enables pivoting motion of the mount 109. In an aspect, the second tilt control element 113 can comprise a cylindrical member (e.g., pin) that passes through aligned openings in the second fastener 108 and the mount 109. The second tilt control element 113 can comprise a roughened surface (e.g., grooves) and/or other mechanism that allows for radial adjustment between fixed positions. The roughened surface can interface with a similar surface disposed on the second fastener 108.

Rotation of the second tilt control element 113 can enable user adjustable angle positioning of the mount 109. As such, the second tilt control element 113 can enable a user to tilt the mount 109 to a desired angle. In an aspect, the second tilt control element 113 can enable user adjustable angle positioning of the mount 109 as described or via any other suitable means. For example, the second tilt control element 113 can comprise an adjustable hinge or any other suitable device/mechanism known in the art.

FIG. 1D and FIG. 1E are views illustrating an example display mount design for a support assembly. FIG. 1D is a side view of the example display mount. FIG. 1E is a front view of the example display mount. The mount 109 can comprise a first plurality of holes 115 for fastening the mount 109 to the second fastener 108. The mount 109 can comprise a second plurality of holes 117 for fastening the mount 109 to the display 110. In some implementations, the 109 can be integrated (e.g., as a single body) into the second fastener 108 without the use of the first plurality of holes 115. For example, the mount 109 can be extend from a rotating portion 119 of the

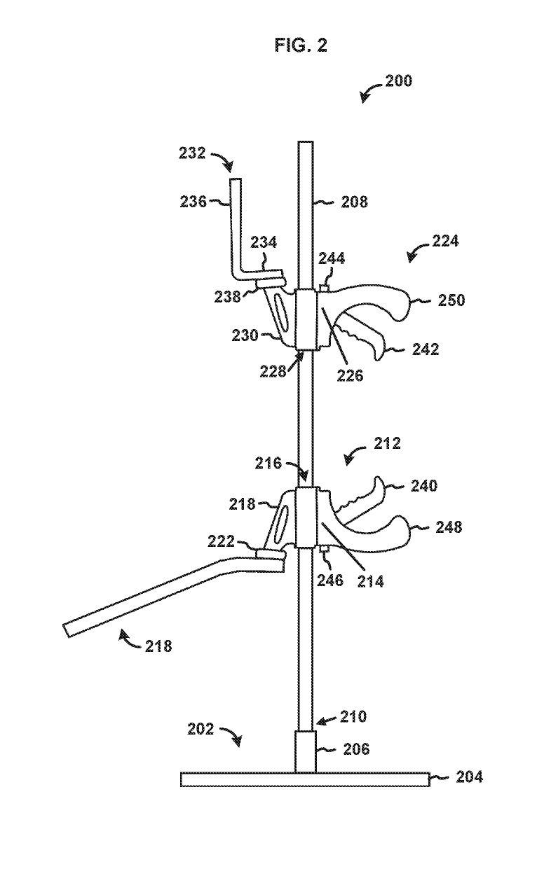

FIG. 2 illustrates another example apparatus 200 for supporting peripherals. In an aspect, the apparatus 200 can comprise a base 202. The base 202 can comprise a flat portion 204. The flat portion 204 can comprise a sheet of a transparent material. The flat portion 204 can be circular, rectangular, and/or the like. The base 202 can comprise a receiving portion 206. The receiving portion 206 can be perpendicular to the flat portion 204. The receiving portion 206 and the flat portion 204 can be molded as one piece or can be two separate pieces. In the case of two separate pieces, at least three legs can used to fasten the receiving portion 206 to the flat portion 204. The legs can be curved or squared to allow for fastening one end of the leg to the receiving portion 206 and another end of the leg to the flat portion 204. The receiving portion 206 can comprise a cavity for receiving a bar 208. The cavity can be shaped to conform around the bar 208. The receiving portion 206 can have a length sufficient to prevent the bar 208 from falling out of the base 202.

The bar 208 can comprise a first end 210 supported by the base 202. The bar 208 can comprise a flattened bar. For example, the depth of the bar 208 can be larger than the width (e.g., the depth is shown in the horizontal direction of FIG. 2). The bar 208 can be rigid. The bar 208 can be made of a steel, aluminum, carbon, a combination thereof, and/or the like. The bar 208 can be vertically positioned.

In an aspect, the apparatus 200 can comprise a first support assembly 212 adjustably mounted on the bar 208. The first support assembly 212 can comprise a first fastener 214. The first fastener 214 can be configured to fix the first support assembly 212 in a position along the bar 208. The first fastener 214 can comprise a first sleeve 216 extending through the first fastener 214. The first sleeve 216 can be configured for mounting the first support assembly 212 on the bar 208. The first sleeve 216 can comprise a cavity disposed through the first fastener 214. The cavity of the first sleeve 216 can be shaped to conform around the bar 208. For example, the cavity can comprise an opening having a slot shape, circular shape, rectangular shape, and/or the like.

The first support assembly 212 can be configured to support a tray 218. The first support assembly 212 can comprise a first mounting element 220 extending from the first fastener 214. The first mounting element 220 can comprise a first planar portion 222, such as a pad. The first planar portion 222 can extend below (e.g., or above) the first mounting element 220. The first mounting element 220 can be affixed to the tray 218. For example, the tray 218 can be affixed to the first planar portion 222 of the first mounting element 220. The tray 218 can be affixed (e.g., via a fastener) to a bottom side of the first planar portion 222 of the first mounting element 220.

In an aspect, the tray 218 can comprise metal (e.g. aluminum or aluminum alloy), acrylic, wood, hardened plastic, and/or any other suitable material. The tray 218 can be in the shape of a rectangle (e.g., with rounded edges). The tray 218 can be substantially planar. The tray 218 can support a first peripheral, such as a keyboard (e.g., as shown in FIG. 1A). In some implementations, the tray 218 can comprise at least a portion of the tray 107 shown in FIG. 1C.

In an aspect, the apparatus 200 can comprise a second support assembly 224 adjustably mounted on the bar 208. The second support assembly 224 can be positioned on the bar 208 above the first support assembly 212. The second support assembly 224 can comprise a second fastener 226. The second fastener 226 can be configured to fix the second support assembly 224 in a position along the bar 208. The second fastener 226 can comprise a second sleeve 228 extending through the second fastener 226. The second sleeve 228 can be configured for mounting the second support assembly 224 on the bar 208. The second sleeve 228 can comprise a cavity disposed through the first fastener 214. The cavity of the second fastener 226 can be shaped to conform around the bar 208. For example, the cavity of the second fastener 226 can comprise an opening having a slot shape, circular shape, rectangular shape, and/or the like.

In an aspect, the first support assembly 212 and/or the second support assembly 224 can comprise bar clamps, such as ratcheting bar clamps. The first support assembly 212 can comprise a first bar clamp, and the second support assembly 224 can comprise a second bar clamp. The first bar clamp can be disposed on the bar 208 for ratcheting motion towards the second bar clamp. The second bar clamp can be disposed on the bar 208 for ratcheting motion towards the first bar clamp. The bar 208 can comprise a slide bar for a bar clamp.

In an aspect, the second support assembly 224 can comprise a second mounting element 230. The second mounting element 230 can be affixed to a mounting bracket 232 configured to mount a display. The mounting bracket 232 can comprise a first portion 234 configured to mount to the second mounting element 230. The mounting bracket 232 can comprise a second portion 236 configured to support a display. For example, fasteners can be used to attach the display to the second portion 236 as further illustrated in FIG. 1D and FIG. 1E. The second mounting element 230 can comprise a second planar portion 238, such as a pad. The second planar portion 238 can extend above (e.g., or below) the second mounting element 230. The mounting bracket 232 can be affixed to the second planar portion 238 of the second mounting element 230.

The first support assembly 212 and the second support assembly 224 can be selectively movable along the bar 208 towards and away from the base 202. The first support assembly 212 can be selectively moveable along the bar 208 independently from the second support assembly 224. The second support assembly 224 can be selectively moveable along the bar 208 independently of the first support assembly 212. For example, the first support assembly 212 can comprise a first trigger 240 for actuating movement of the first support assembly 212 along the bar 208. Actuation of the first trigger 240 can cause movement in a direction opposite of the actuation. The second support assembly 224 can comprise a second trigger 242 for actuating movement of the second support assembly 224 along the bar 208. Actuation of the second trigger 242 can cause movement in a direction opposite of the actuation.

The first support assembly 212 can comprise a first locking mechanism as shown in FIG. 3A and FIG. 3B) for locking the first support assembly 212 in place along the bar 208 when the first trigger 240 is not actuated. The second support assembly 224 can comprise a second locking mechanism (e.g., as shown in FIG. 3A and FIG. 3B) for locking the second support assembly 224 in place along the bar 208 when the second trigger 242 is not actuated. The first support assembly 212 can comprise a first release button 244 (e.g., or third trigger). The first release button 244 can be pressed, thereby releasing engagement of the first fastener 214 with the bar 208. The second support assembly 224 can comprise a second release button 246 (e.g., or fourth trigger). The second release button 246 can be pressed, thereby releasing engagement of the first fastener 214 with the bar 208. The first locking mechanism and/or second locking mechanism can comprise a first surface normally engaging the bar 208 thereby preventing movement of the first locking mechanism or second locking mechanism along the bar 208 when the first trigger 240 or the second trigger 242 is not actuated. The first locking mechanism and/or second locking mechanism can comprise a first driving lever which binds against a surface of the bar 208 and moves the first support assembly 212 along the bar 208 in response to actuation of the first trigger 240. Example locking mechanism are shown in FIG. 3A and FIG. 3B and described in further detail in the accompanying description.

The first support assembly 212 can be configured to rotate around the bar 208 (e.g., when the first locking mechanism is disengaged). For example, if the bar 208 is round, the first sleeve 216 can be cylindrically shaped. The second support assembly 224 can be configured to rotate around the bar 208. For example, if the bar 208 is round, the second sleeve 228 can be cylindrically shaped. The first support assembly 212 can comprise a first handle 248 for griping the first support assembly 212 when moving the first support assembly 212. The second support assembly 224 can comprise a second handle 250 for griping the second support assembly 224 when moving the second support assembly 224.

In an aspect, the apparatus 200 can have the advantage of being lightweight and portable in comparison to other sit to stand devices. For example, the apparatus 200 can weigh less than or equal to 10 pounds. The base 202, the tray 218, and/or the mounting bracket 232 can be made of a lightweight material, such as plastic, acrylic, tempered glass, aluminum, a combination thereof, and/or the like. The bar 208 can have a width smaller than a depth (e.g., the side view of FIG. 2 illustrates the depth) to make the bar 208 more lightweight while also maintaining strength in the direction in which force is applied by a user.

FIG. 3A is a side view of a fastener illustrating an example locking mechanism 302. The locking mechanism 302 can be disposed within any fastener described herein (e.g., the first fastener 106 of FIG. 1A, the second fastener 108 of FIG. 1A, the first fastener 214 of FIG. 2, the second fastener 226 of FIG. 2).

The locking mechanism 302 can comprise a first lever 304. The first lever 304 can be configured to lock the fastener with respect to a bar 305. The locking mechanism 302 can comprise a second lever 306. The second lever 306 can be configured to advance the fastener along the bar 305.

The first lever 304 and the second lever 306 can comprise a rigid material (e.g., metal, plastic, wood, etc.). The first lever 304 and the second lever 306 can each comprise a respective opening 308 for receiving the bar 305. FIG. 3B illustrates an example opening 308. FIG. 3B is a bottom up view illustrating a lever engaged against the bar 305 (e.g., at an angle to the bar 305, thereby exhibiting a force upon the bar 305). The opening 308 can be in the center of the respective lever or offset from the center. The opening 308 can be any shape, such as circular, elliptical, rectangular, triangular, star shaped, and/or the like. The width (e.g., diameter) of the opening 308 can be slightly larger than the width (e.g., diameter) of the bar 105.

Returning to FIG. 3A, the first lever 304 can be configured as a braking lever. For example, the first lever 304 can be biased (e.g., disposed at an angle) to apply a force against the bar 105 (e.g., or the bar 205). The first lever 304 can be positioned between a first spring 310 and a first blocking element 312. The first spring 310 can apply a force to the first lever 304. The first blocking element 312 can block a top portion of the first lever 304, such that the bottom portion of the first lever 304 is pushed further to the left than the top portion of the first lever 304. A release button 314 can be configured to engage an opposite side of the bottom portion of the first lever 304, thereby disengaging the first lever 304 from the bar 305.

The second lever 306 can be configured to advance the fastener along the bar 305. A second spring 316 (e, g., disposed around the bar 305) can press the second lever 306 against a set of second blocking elements 318. A trigger 320 can be configured to engage with a bottom portion of the second lever 306. A top portion 322 of the trigger 320 (e.g., as the top portion 322 rotates) can engage with the bottom portion of the second lever 306 moving the bottom portion of the second lever 306 (e.g., to the right) against the second spring 316. This movement causes the second lever 306 to engage against the bar 305. As the trigger 320 is released, the second spring 316 can push the second lever 306 back into original position (e.g., against the second blocking elements 318). This movement can cause the fastener to advance along the length of the bar 305.

In some implementations, the locking mechanism 302 can be implemented without the trigger 320. For example, the locking mechanism 302 can comprise the first lever 304, the first blocking element 312, and the release button 314, and the first spring 310 (e.g., without the trigger 320, the second lever 306, and/or the second spring 316). The fastener can be adjusted by disengaging the first lever 304 via the release button 314 and re-engaging the first lever 304 by releasing the release button 314.

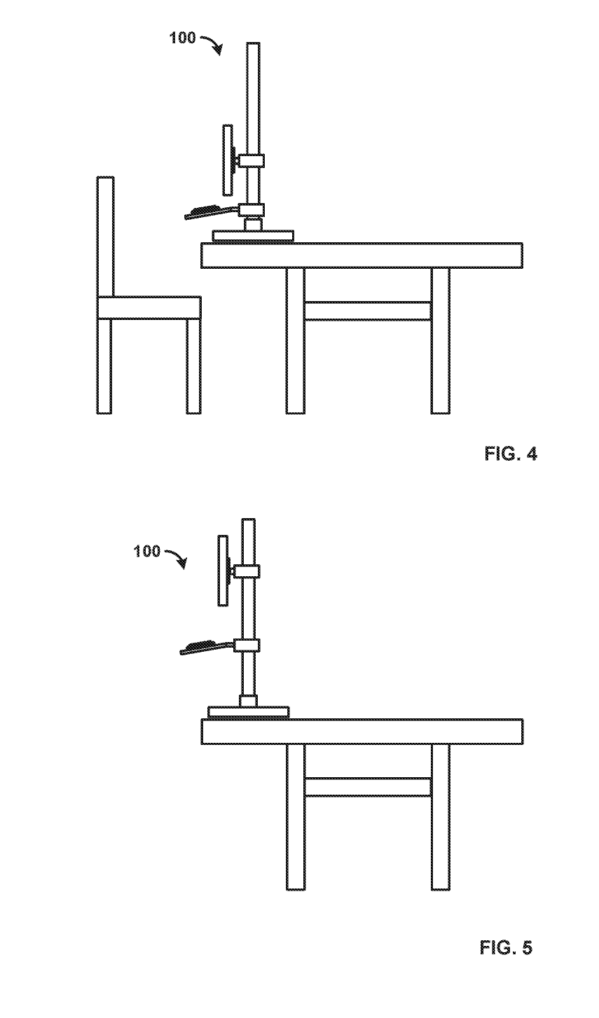

Several advantages result from the apparatus, systems and methods of the present disclosure. For example, the viewing height of a monitor is adjustable by the user to accommodate different monitor/display devices and/or to attain a particular viewing angle. In an aspect, the position of the first and second support assemblies may be adjusted such that a user may use the apparatus as a computer docking station/terminal while in a seated position. FIG. 4 is an illustration of the apparatus 100 configured for use by a user in a seated position.

In another aspect, the position of the first and second support assemblies may be adjusted such that a user may use the apparatus 100 as a computer docking station/terminal while in a standing position. The base of the apparatus 100 may be placed on a floor or alternatively atop furniture according to user preference. FIG. 5 is an illustration of the apparatus 100 configured for use by a user in a standing position.

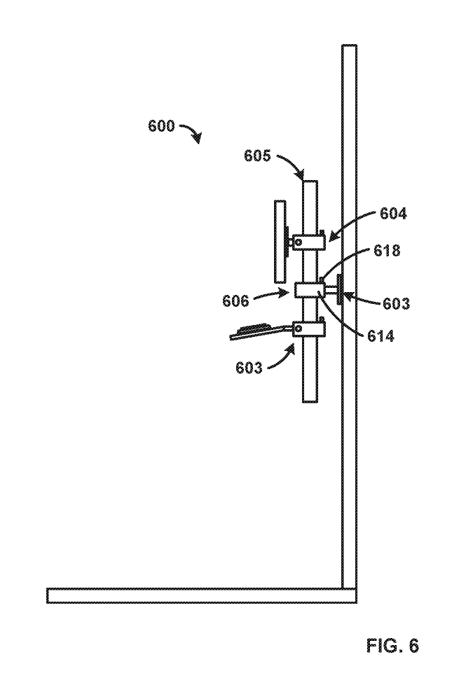

In yet another aspect, as depicted in FIG. 6, an example apparatus 600 can be configured to be attached to a vertical surface, e.g., a wall. The apparatus 600 can be a modified version of the apparatus 100 of FIG. 1A or the apparatus 200 of FIG. 2. For example, the apparatus 600 can comprise a bar 605, a first support assembly 603, a second support assembly 604 similar to those shown in FIG. 1A and/or FIG. 2. The apparatus 600 can comprise a third support assembly 606 positioned along the bar 605 between the first support assembly 603 and the second support assembly 604. The third support assembly 606 can comprise a third fastener 614. The third fastener 614 can be disposed around the bar 605. The position of the third fastener 614 along the bar 605 can be adjusted by disengaging a locking mechanism via a release button 618. When the third fastener 614 is unlocked from a position along the bar 605 a user can move the third fastener 614 along the length of bar 605. The third support assembly 606 can be selectively moved along the bar 605 independently from the first support assembly 603 and the second support assembly 604. The third support assembly 606 can comprise a wall mount 620 configured to mount the apparatus 100 to a wall via screws, enforced adhesive, or any other suitable fastening mechanism.

In an aspect, the apparatuses described herein can be at least partially included via a kit. For example, the kit can comprise a portion of the apparatus that can be combined with other household items, such as a bar clamp (e.g., ratcheting bar clamp). The kit can comprise any combination of the parts described herein. For example, kit can comprise the tray 107 and the mount 109. The kit can comprise fasteners for attaching the tray 107 and the mount 109 to pads (e.g., first planar portion, second planar portion) of ratcheting members (e.g., described as support assemblies or bar clamps herein) of a bar clamp. The kit can comprise a base 102 for supporting the bar. The kit can comprise one or more support assemblies as described herein. The kit can comprise instructions for converting a bar clamp into one or more of the apparatuses described herein (e.g., into a sit to stand desk). The instructions can instruct a purchaser to reconfigure one or more ratcheting members. For example, the purchaser can be instructed to remove the pads (e.g., and pad support mounted to the top of the ratcheting member, first mounting element, second mounting element) of a ratcheting member and reattach the pads in the opposite direction. For example, the instructions can instruct a purchaser to remove a ratcheting member from the bar and place the ratcheting member back on the bar in the opposite direction than originally disposed. The instructions can instruct a purchaser to place one end of the bar in the base 102. The kit can comprise fasteners for attaching a monitor to the mount 109. The kit can comprise fasteners for attaching the base 102 to a bar of a bar clamp.

While the methods and systems have been described in connection with preferred embodiments and specific examples, it is not intended that the scope be limited to the particular embodiments set forth, as the embodiments herein are intended in all respects to be illustrative rather than restrictive.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is in no way intended that an order be inferred, in any respect. This holds for any possible non-express basis for interpretation, including: matters of logic with respect to arrangement of steps or operational flow; plain meaning derived from grammatical organization or punctuation; the number or type of embodiments described in the specification.

It will be apparent to those skilled in the art that various modifications and variations can be made without departing from the scope or spirit. Other embodiments will be apparent to those skilled in the art from consideration of the specification and practice disclosed herein. It is intended that the specification and examples be considered as exemplary only, with a true scope and spirit being indicated by the following claims.

What is claimed is:

1. An apparatus for supporting computer peripherals, comprising:
a bar;
a first support assembly comprising a first fastener mounted on the bar and adjustable for selective positioning along the bar, wherein the first support assembly comprises a tray attached to the first fastener; and
a second support assembly comprising a second fastener mounted on the bar and adjustable for selective positioning along the bar, wherein the second support assembly comprises a mount configured to mount a display to the second fastener, wherein the second fastener is selectively moveable along the bar independently from the first fastener and the first fastener is selectively moveable along the bar independently of the second fastener.

2. The apparatus of claim 1, wherein the first fastener comprises a first trigger and the second fastener comprises a second trigger, and wherein actuation of the first trigger moves the first fastener along the bar and actuation of the second trigger moves the second fastener along the bar.

3. The apparatus of claim 2, wherein the first fastener comprises a first locking mechanism configured to lock the first fastener in position along the bar when the first trigger is released, and wherein the second fastener comprises a second locking mechanism configured to lock the second fastener in position along the bar when the second trigger is released.

4. The apparatus of claim 1, wherein the bar is vertically positioned above a base, and wherein the first fastener and the second fastener are selectively movable along the bar towards and away from the base.

5. The apparatus of claim 1, wherein the base comprises a clamp configured to lock the base to a supporting surface.

6. The apparatus of claim 1, wherein the tray comprises lightweight material.

7. The apparatus of claim 1, wherein the second support assembly is positioned on the bar above the first support assembly.

8. The apparatus of claim 1, wherein the bar comprises one of a round, hollow, and rectangular shape.

9. The apparatus of claim 1, further comprising a base supporting the bar, wherein the base comprises a sheet of harden material and at least three legs connecting the bar to the sheet.

10. The apparatus of claim 1, wherein the apparatus is portable, wherein the portability is accomplished by detaching the bar from a base and detaching first support assembly and the second support assembly from the bar.

11. An apparatus for supporting computer peripherals, comprising:
a base;
a bar having a first end supported by the base;
a first support assembly adjustably mounted on the bar, wherein the first support assembly comprises a first fastener, a first trigger for actuating movement of the first support assembly along the bar, and a first mounting element extending from the first fastener, wherein the first fastener comprises a first sleeve extending through the first fastener and configured for mounting the first support assembly on the bar, and wherein the first mounting element is affixed to a tray; and
a second support assembly adjustably mounted on the bar, wherein the second support assembly comprises a second fastener, a second trigger for actuating movement of the second support assembly along the bar, and a second mounting element extending from the second fastener, wherein the second fastener comprises a second sleeve extending through the second fastener and configured for mounting the second support assembly on the bar, wherein the second mounting element is affixed to a mounting bracket configured to mount a display, and wherein the first support assembly is selectively moveable along the bar independently from the second support assembly and the second support assembly is selectively moveable along the bar independently of the first support assembly.

12. The apparatus of claim 11, wherein the first support assembly is configured to rotate around the bar.

13. The apparatus of claim 11, wherein the first support assembly comprises a first locking mechanism for locking the first support assembly in place along the bar when the first trigger is not actuated, and wherein the second support assembly comprises a second locking mechanism for locking the second support assembly in place along the bar when the second trigger is not actuated.

14. The apparatus of claim 11, wherein the first locking mechanism comprises a first surface normally engaging the bar thereby preventing movement of the first locking mechanism along the bar when the first trigger is not actuated, and wherein the first support assembly comprises a first driving lever which binds against a surface of the bar and moves the first support assembly along the bar in response to actuation of the first trigger.

15. The apparatus of claim 11, wherein the bar is vertically positioned, and wherein the first support assembly and the second support assembly are selectively movable along the bar towards and away from the base.

16. The apparatus of claim 11, wherein actuation of the first trigger causes movement in a direction opposite of the actuation.

17. The apparatus of claim 11, wherein the second support assembly is positioned on the bar above the first support assembly.

18. The apparatus of claim 11, wherein the base comprises a sheet of a transparent material and at least three legs connecting the bar to the sheet.

19. The apparatus of claim 11, wherein the apparatus weighs less than 10 pounds.

20. A method for configuring a support device, comprising:
adjusting a first support assembly to a first position on the bar, wherein the first support assembly comprises a first fastener mounted on the bar and adjustable for selective positioning along the bar, and wherein the first support assembly comprises a tray attached to the first fastener;
adjusting a second support assembly to a second position along a bar, wherein the second support assembly comprises a second fastener mounted on the bar and adjustable for selective positioning along the bar, wherein the second support assembly comprises a mount configured to mount a display to the second fastener;
attaching the display to the mount; and
placing a keyboard upon the tray.
